(19) United States
(12) Patent Application Publication
(10) Pub. No.: US 2004/0173300 A1
(43) Pub. Date: Sep. 9, 2004

(54) Rubber bonded brass composite material

(75) Inventors: Tatsuya Yasunaga, Kobe-shi (JP); Hisashi Mitamura, Takasago-shi (JP); Takenori Nakayama, Kobe-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Kobe Seiko Sho (Kobe Steel Ltd.), Kobe-shi (JP)

(21) Appl. No.: 10/790,019

(22) Filed: Mar. 2, 2004

(30) Foreign Application Priority Data
Mar. 3, 2003 (JP) 2003-055944

(51) Int. Cl. B05D 3/02; B32B 15/06

(52) U.S. Cl. 152/565; 427/318; 428/625

(57) ABSTRACT

A rubber-bonded brass composite material prepared by bonding rubber to the surface of a brass-plated material obtained by plating the surface of a substrate with brass or to the surface of a brass material by vulcanization, wherein preheating is carried out before vulcanization to form needle-like Cu—S-based reaction products at the bonding interface between brass and rubber. Thereby, there is provided a rubber-bonded brass composite material having excellent long-term adhesion while excellent initial adhesion at the time of bonding by vulcanization is retained.

### BACKGROUND OF THE INVENTION

1. Field of the Invention

The present invention relates to a bonded composite material of a brass-plated material or brass material and rubber, for example, a rubber-bonded brass composite material prepared by bonding rubber to the surface of a brass-plated material, which is used as a steel yarn stock (such as a steel cord or bead wire) for reinforcing a tire, hose or industrial belt. Specifically, it relates to a rubber-bonded brass composite material having excellent adhesion to rubber. The composite material of the present invention includes any one of a brass-plated material and a brass material to which rubber is bonded but a case where a brass-plated material is used is mainly described hereinbelow.

2. Description of the Prior Art

For the above applications, a technique for bonding rubber to a brass-plated material obtained by subjecting the surface of a substrate to wet type brass plating by vulcanization is widely employed to improve adhesion between a metal material as the substrate and rubber. A typical example of the technique is bonding of a brass-plated steel wire to rubber for the manufacture of an auto tire.

The above brass-plated steel wire is obtained by forming a brass plating layer on the surface of a wire material before drawing and by drawing the resulting wire. The brass plating layer on the steel wire is generally obtained by forming a steel plating layer on the wire material by wet type electroplating and a wet type electrogalvanizing layer and then alloying the both metals by heating.

In the above bonded material (composite material) of a brass-plated material and rubber, the improvement of adhesion to rubber is based on the proceeding of a chemical bonding reaction (crosslinking reaction) between copper (Cu) contained in the brass plating layer and sulfur (S) contained in the rubber. Therefore, it is requisite to the improvement of adhesion that the reaction between copper and sulfur is realized in as large an area as possible.

In recent years, large-sized tires used for trucks and buses have often been used two times or three times by re-treading after their primary service lives for recycling, and demand for tires having a longer service life and long-term stable adhesion (long-term adhesion) between a steel cord and rubber when in use has been growing.

Various proposals have been made to improve adhesion to rubber. For example, there has been proposed a technique for improving adhesion between rubber and a brass-plated material by removing an organic compound adhered to the brass-plated surface due to a wet type lubricant at the time of drawing by mechanical polishing or cleaning with an alkaline solution so as to increase the ratio of a metal exposed to the brass-plated surface (for example, JP-A 2001-131885 and JP-A 2001-234371) (the term “JP-A” as used herein means an “unexamined published Japanese patent application”).

However, when the tire is used for a long time by re-treading, adhesion right after bonding by vulcanization (to be referred to as “initial adhesion” hereinafter) must be high and extremely high bonding strength must be maintained for a long time (long-term adhesion). It is difficult to obtain bonding strength which meets recent demand with the above technique.

### SUMMARY OF THE INVENTION

It is an object of the present invention which has been made in view of the above situation to provide a rubber-bonded brass composite material which has high initial adhesion at the time of bonding by vulcanization and long-term adhesion.

The above object of the present invention can be attained by a rubber-bonded brass composite material prepared by bonding rubber to the surface of a brass-plated material obtained by plating the surface of a substrate with brass or to the surface of a brass material by vulcanization, wherein needle-like Cu—S-based reaction products are formed at the bonding interface between brass and rubber.

When the section of the bonding interface between brass and rubber of the rubber-bonded brass composite material of the present invention is observed through a transmission electron microscope (TEM), 1 to 50 needle-like Cu—S-based reaction products having a length L of 10 nm or more and an L (length)/W (width) ratio of 5 or more are preferably existent based on 1 μm in the length of the section of the bonding interface.

Typical examples of the brass-plated material used in the above composite material include steel cords and bead wires for tires. The composite material of the present invention has excellent adhesion to rubber and when it is used in a tire, it can be used stably for a long time while it retains excellent adhesion.

It can be said that the rubber-bonded brass composite material of the present invention which can attain the above object is a composite material obtained by bonding rubber to the surface of a brass-plated material obtained by plating the surface of a substrate with brass or to the surface of a brass material by vulcanization, wherein preheating is carried out at 80 to 120° C. before vulcanization.

Since the rubber-bonded brass composite material of the present invention is constituted as described above, it has excellent initial adhesion and long-term adhesion between rubber and the brass-plated material or brass material.

### BRIEF DESCRIPTION OF THE DRAWINGS

FIGS. 1A to 1C are diagrams schematically showing various forms of the Cu—S-based reaction products;

FIG. 2 is a schematic diagram for explaining the method of counting needle-like Cu—S-based reaction products;

FIG. 3 is a TEM photo showing the brass plating/rubber interface of a rubber-bonded brass-plated composite material which was manufactured by 15 minutes of vulcanization at 160° C. after it was preheated at 100° C. for 10 minutes;

FIG. 4 is a TEM photo showing the brass plating/rubber interface of a rubber-bonded brass-plated composite material which was manufactured by 15 minutes of vulcanization at 160° C. after it was preheated at 100° C. for 20 minutes; and

FIG. 5 is a TEM photo showing the brass plating/rubber interface of a rubber-bonded brass-plated composite material which was manufactured by 15 minutes of vulcanization at 160° C. without preheating.

### DETAILED DESCRIPTION OF THE PREFERRED EMBODIMENT

The inventors of the present invention have studied means of improving adhesion between brass plating and rubber (initial adhesion and long-term adhesion) from various aspects. As a result, it has been found that excellent adhesion between brass plating and rubber can be obtained by controlling reaction products (Cu—S-based reaction products) containing Cu and S formed at the interface between brass plating and rubber to an appropriate form. That is, it was found that adhesion to rubber can be improved due to the existence of needle-like Cu—S-based reaction products formed at the interface between brass plating and rubber after vulcanization which is carried out after a pre-heating step is carried out on an unvulcanized green tire at 80 to 120° C. The present invention has been accomplished based on this finding.

In the rubber-bonded brass-plated composite material of the present invention, when the bonding interface between brass plating and rubber is observed through TEM, 1 to 50 needle-like Cu—S-based reaction products having a length L of 10 nm or more and an L (length)/W (width) ratio of 5 or more are preferably existent based on 1 μm in the length of the section of the bonding interface.

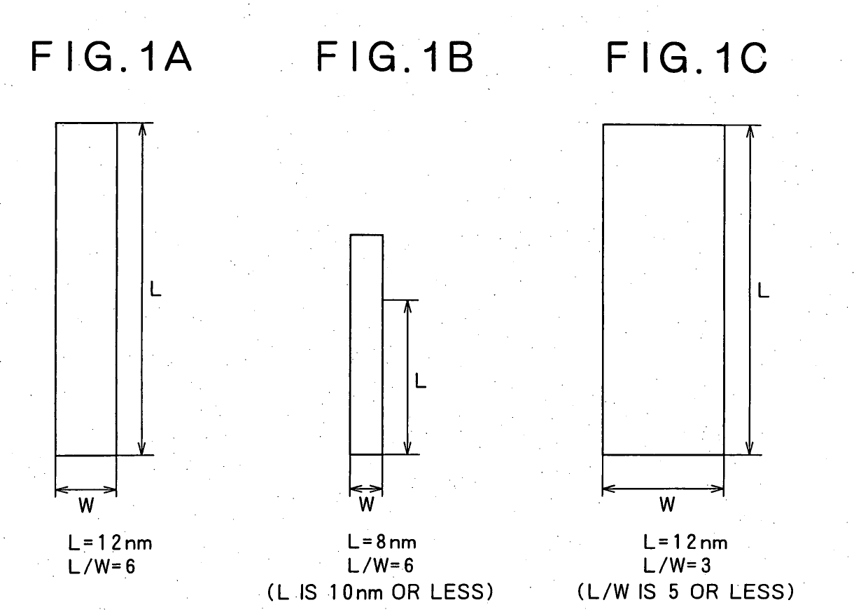

A description is subsequently given of the forms of the needle-like Cu—S-based reaction products which contribute to adhesion to rubber. FIGS. 1A to 1C are diagrams schematically showing various forms of the Cu—S-based reaction products. The Cu—S-based reaction product shown in FIG. 1A has a length L of 12 nm (that is, more than 10 nm) and an L (length)/W (width) ratio (L/W: aspect ratio) of 6 (that is, more than 5). In contrast to this, the Cu—S-based reaction product shown in FIG. 1B has an L/W ratio of 6 but a length of 8 nm (that is, less than 10 nm). The Cu—S-based reaction product shown in FIG. 1C has a length L of 12 nm (that is, more than 10 nm) but an L/W ratio of 3 (that is, less than 5).

In the present invention, the needle-like Cu—S-based reaction products shown in FIG. 1A which contributes to adhesion to rubber are counted, and the needle-like Cu—S-based reaction products shown in FIGS. 1B and 1C are not counted because they do not contribute to adhesion to rubber.

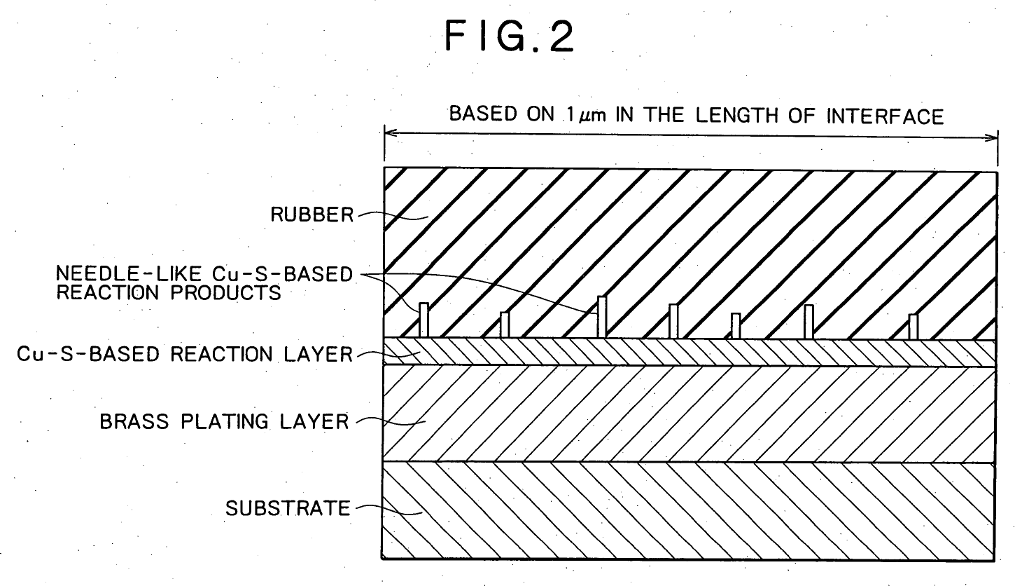

FIG. 2 is a schematic diagram for explaining the method of counting the needle-like Cu—S-based reaction products. Out of the Cu—S-based reaction products existent when the section (section perpendicular to the brass plating surface) of the bonding interface between brass plating and rubber is observed through a transmission electron microscope, the Cu—S-based reaction products shown in FIG. 1A (that is, a length L of 10 nm or more and an L/W ratio of 5 or more) are counted (based on 1 μm in the length of the interface) (seven in FIG. 2).

When 1 or more of the needle-like Cu—S-based reaction products shown in FIG. 1A are existent based on 1 μm the length of the interface, excellent adhesion to rubber is obtained. The number of the needle-like Cu—S-based reaction products is preferably 2 or more, more preferably 3 or more.

When the above needle-like Cu—S-based reaction products are existent too densely, the elastic deformation ability of the reaction products deteriorates, whereby the Cu—S-based reaction products agglomerate, resulting in reduced adhesion to rubber. From this point of view, the number of the needle-like Cu—S-based reaction products is preferably 50 or less, more preferably 40 or less, much more preferably 30 or less based on 1 μm in the length of the bonding interface.

To obtain the suitable needle-like Cu—S-based reaction products (FIG. 1A) at an appropriate density, it is effective to carry out preheating before vulcanization. The preheating conditions (temperature and time) must be suitably controlled. The preheating temperature is suitably 80 to 120° C., preferably 90 to 110° C. The preheating time must be suitably adjusted according to the preheating temperature. When the preheating temperature is lower than 80° C., a needle-like reaction layer is not formed. When the preheating temperature is higher than 120° C., vulcanization starts during preheating, thereby making it difficult to form the needle-like Cu—S-based reaction products. For example, when preheating is carried out at 100° C., a preheating time of about 10 minutes is suitable (see No. 10 in Table 1). The optimum conditions change according to the components and composition of a rubber compound. It is important that the optimum form at the interface of the composite material of the present invention should be achieved. To this end, the conditions must be suitably set.

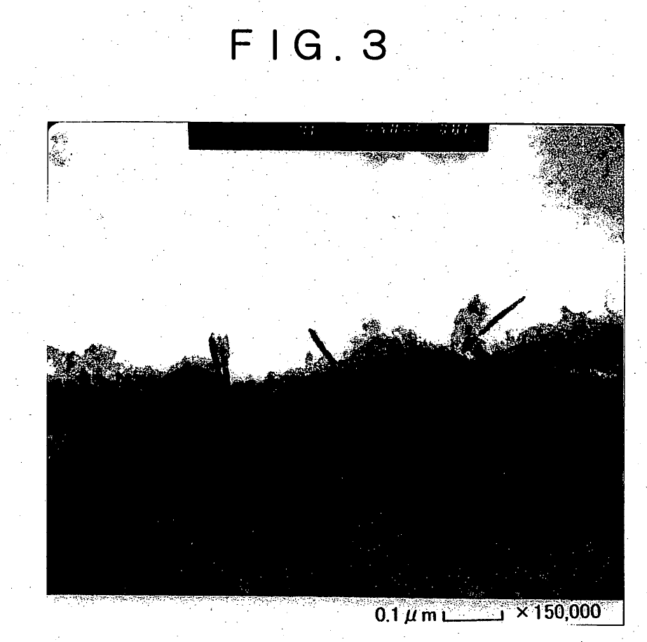

FIG. 3 shows the TEM observation result of the section of the interface between brass plating and rubber of a rubber-bonded brass-plated composite material which was manufactured by 15 minutes of vulcanization at 160° C. after 10 minutes of preheating at 100° C. As obvious from this figure, needle-like projections are observed in the Cu—S-based reaction product and the needle-like projections are also the Cu—S-based reaction product. When a predetermined number of the needle-like Cu—S-based reaction products are formed, excellent adhesion to rubber is obtained.

Since the Cu—S-based reaction product is less elastically deformed than rubber and metals, it easily becomes the starting point of destruction in an agglomerated form. However, when it is distributed in a needle-like form, it can follow elastic deformation to a certain extent as the whole reaction layer, thereby improving the adhesion of the whole Cu—S-based reaction layer.

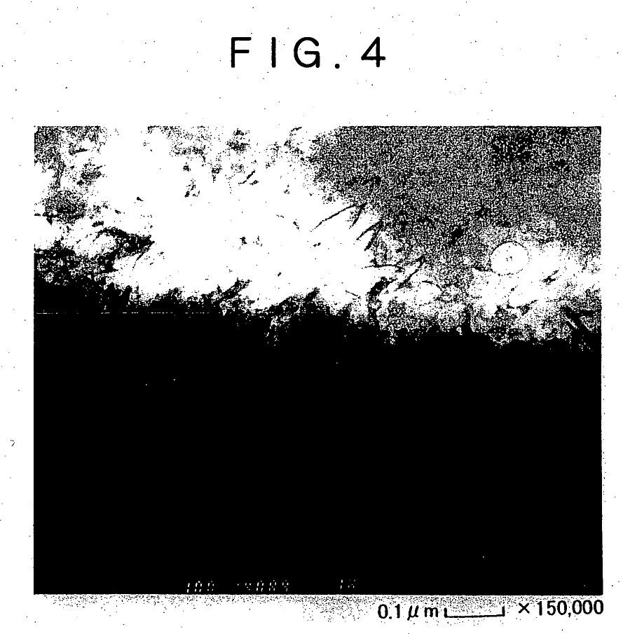

FIG. 4 shows the TEM observation result of the section of the interface between brass plating and rubber of a rubber-bonded brass-plated composite material which was manufactured by 15 minutes of vulcanization at 160° C. after 20 minutes of preheating at 100° C. As compared with the case where the preheating time is 10 minutes, the number of the needle-like projections is extremely large. In this case, adhesion and durability deteriorate (No. 11 in Table 1). This is because the elastic deformation of the reaction product deteriorates due to the high density of the needle-like Cu—S-based reaction products, whereby the Cu—S-based reaction products agglomerate.

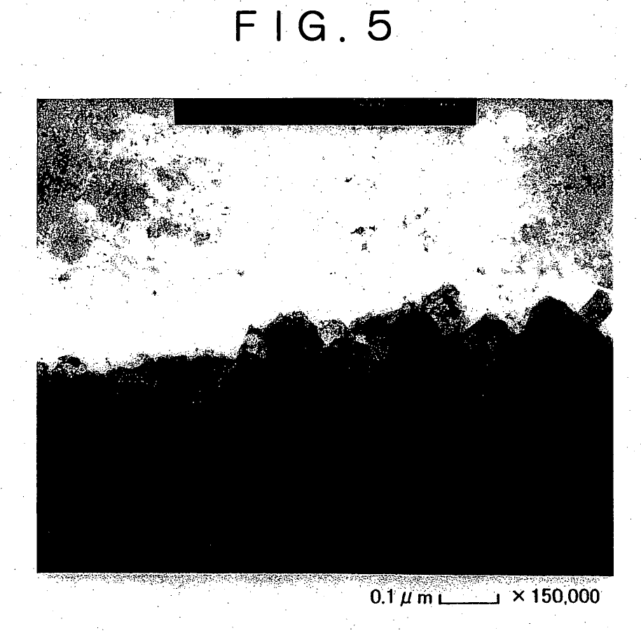

When vulcanization is carried out at 160° C. for 15 minutes without preheating, brass plating and crude rubber are bonded together to form a Cu—S-based reaction layer at the interface. FIG. 5 shows the TEM observation result of the section of the interface between brass plating and rubber of the thus manufactured rubber-bonded brass-plated composite material. This composite material is obtained without preheating and a cloud-like Cu—S-based reaction layer is observed between brass plating and rubber and is essentially composed of a Cu—S-based compound. Due to the existence of this Cu—S-based reaction layer, adhesion between brass plating and rubber is secured. However, as there is no needle-like Cu—S-based reaction product, adhesion to rubber becomes unsatisfactory (No.1 in Table 1).

The needle-like Cu—S-based reaction products are formed after vulcanization. It is considered that Cu—S seed crystals from which the needle-like Cu—S-based reaction products grow are formed at the interface after preheating is completed. To form the Cu—S seed crystals, brass plating and rubber must be contacted to each other at the time of preheating.

The forms of the needle-like Cu—S-based reaction products after vulcanization are controlled by preheating before vulcanization to obtain a rubber/brass plating composite material having high bonding strength between brass plating and rubber. A typical example of the composite material is a tire obtained by bonding (burying) a steel cord or bead wire for reinforcing rubber.

Typical examples of the material to be bonded (substrate) to which the brass-plated material of the present invention can be applied include steel cords and steel wires such as a bead wire (twisted wires or monofilaments) for reinforcing rubber. Steel materials, aluminum materials, copper materials and titanium materials may also be used if a brass plating layer can be well bonded to the surfaces thereof. The above effect can be obtained effectively when any one of the above materials is used. The effect of the present invention is obtained effectively even when a brass material is used in place of the brass-plated material.

As for the composition of brass plating formed in the brass-plated material of the present invention, a brass-plated material having a copper content of 50 to 90 wt % and a zinc content of 50 to 10 wt % may be used. From the viewpoint of balance between wire drawability and adhesion, a steel cord having a copper content of 60 to 70 wt % and a zinc content of 40 to 30 wt % is preferred.

The following examples are provided to further illustrate the present invention.

### EXAMPLES

After a general steel cord for tires (thickness of brass plating: about 0.2 μm) was cut to a length of 20 cm, three cords were twisted together and buried in a rubber material (ordinary tire rubber based on natural rubber) based on ASTM D2229, and the resulting product was preheated at 100° C. for 0 (no preheating) to 26 minutes and vulcanized at 160° C. for 15 minutes to be bonded.

The initial adhesion of the above vulcanized bonded material (composite material) right after vulcanization and the long-term adhesion of the composite material after it was left in a wet environment, (75° C., 95 % RH) for 72 hours after vulcanization were examined.

A drawing test based on the above ASTM system is known as a standard test for the evaluation of adhesion between a steel yarn stock and rubber. In this drawing test, drawing force is rated when a steel wire is drawn, and adhesion to rubber is evaluated according to the adhesion of rubber to the surface of the steel wire. In this example, drawing force was used to evaluate the performance of the wire as a ratio when a value obtained without preheating was 100%.

As for the same sample as in the drawing test, the section of the bonding interface of the whole bonding layer was observed through TEM to check the form of a Cu—S-based reaction product and count the number of needle-like Cu—S-based reaction products existent based on 1 μm in the length of the bonding interface according to regulations shown in FIGS. 1A to 1C and FIG. 2. TEM observation was carried out at 10 positions for each preheated sample and the average of the count values in 10 view fields was taken as the number of the needle-like Cu—S-based reaction products of the sample. These measurement results are shown in Table 1 together with the preheating time.

TABLE 1

| | | Number of | | |
|---|---|---|---|---|
| | | needle-like Cu—S-based | | |
| | Preheating | reaction products based | | |
| | time | on 1 μm in the length | Initial | Long-term |
| No. | (min) | of the bonding interface | adhesion | adhesion |
| 1 | 0 | None | 100 | 100 |
| | (Not preheated) | | | |
| 2 | 2 | 0.2 | 101 | 103 |
| 3 | 4 | 1.2 | 120 | 122 |
| 4 | 6 | 2.1 | 131 | 130 |
| 5 | 8 | 3.5 | 142 | 141 |
| 6 | 10 | 5.2 | 150 | 150 |
| 7 | 12 | 15.5 | 153 | 151 |
| 8 | 14 | 22.5 | 140 | 142 |
| 9 | 16 | 32.2 | 133 | 131 |
| 10 | 18 | 45.5 | 121 | 120 |
| 11 | 20 | 53.2 | 101 | 99 |
| 12 | 22 | 64.5 | 98 | 100 |
| 13 | 24 | 72.2 | 97 | 98 |
| 14 | 26 | 80.5 | 98 | 99 |

The following can be concluded from the above results. A composite material having 1 to 50 needle-like Cu—S-based reaction products (based on 1 μm in the length of the interface) has a bonding strength of 120% or more, a composite material having 2 to 40 needle-like Cu—S-based reaction products has a bonding strength of 130% or more, and a composite material having 3 to 30 needle-like Cu—S-based reaction products has a bonding strength of 140% or more. Therefore, it can be understood that they have excellent adhesion to rubber.

In contrast to these, a composite material having less than 1 needle-like Cu—S-based reaction product (No. 2) and a composite material having more than 50 needle-like Cu—S-based reaction products (Nos. 11 to 14) have the same or lower bonding strength than a composite material obtained without preheating.

What is claimed is:

1. A composite material prepared by bonding rubber to the surface of a brass-plated material obtained by plating the surface of a substrate with brass or to the surface of a brass material by vulcanization, wherein
needle-like Cu—S-based reaction products are formed at the bonding interface between brass and rubber,
and wherein preheating is carried out at 80 to 120° C. before vulcanization.

2. The rubber-bonded brass composite material according to claim 1, wherein when the section of the bonding interface between brass and rubber is observed through a transmission electron microscope, 1 to 50 needle-like Cu—S-based reaction products having a length L of 10 nm or more and a ratio of the length L to the width W (L/W) of 5 or more are existent based on 1 μm in the length of the section of the bonding interface.

3. The rubber-bonded brass composite material according to claim 1, wherein the brass-plated material or brass material is a steel cord or bead wire for tires.

4. The rubber-bonded brass composite material according to claim 3, wherein the composite material is a tire.
